(19) United States
(12) Patent Application Publication
(10) Pub. No.: US 2024/0267879 A1
(43) Pub. Date: Aug. 8, 2024

(54) SYSTEMS AND METHODS FOR NETWORK BASED POSITIONING

(71) Applicant: ZTE Corporation, Shenzhen (CN)

(72) Inventors: Fangyu CUI, Shenzhen (CN); Nan ZHANG, Shenzhen (CN); Jianwu DOU, Shenzhen (CN); Wei CAO, Shenzhen (CN)

(73) Assignee: ZTE Corporation, Shenzhen (CN)

(21) Appl. No.: 18/618,522

(22) Filed: Mar. 27, 2024

Related U.S. Application Data
(63) Continuation of application No. PCT/CN2022/086957, filed on Apr. 15, 2022.

(51) Int. Cl. H04W 64/00; G01S 13/76

(52) U.S. Cl. CPC H04W 64/00; G01S 13/76

(57) ABSTRACT

Presented are systems and methods for network based positioning. A wireless communication device may send at least a first positioning-related information of a first time instance and a second positioning-related information of a second time instance to a wireless communication node. The first positioning-related information and the second positioning-related information can be to use collectively to perform a network based determination of a single location of the wireless communication device.

### CROSS-REFERENCE TO RELATED APPLICATION

This application claims the benefit of priority under 35 U.S.C. § 120 as a continuation of PCT Patent Application No. PCT/CN2022/086957, filed on Apr. 15, 2022, the disclosure of which is incorporated herein by reference in its entirety.

### TECHNICAL FIELD

The disclosure relates generally to wireless communications, including but not limited to systems and methods for network based positioning.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A wireless communication device (e.g., user equipment) may send at least a first positioning-related information of a first time instance and a second positioning-related information of a second time instance to a wireless communication node (e.g., base station). The first positioning-related information and the second positioning-related information can be used collectively to perform a network based determination of a single location of the wireless communication device. In some embodiments, the wireless communication device may determine at least a first measurement of a receipt time of a first downlink reference signal, and a second measurement of a receipt time of a second downlink reference signal. The wireless communication device may determine at least a first time gap between the first receipt time and a first transmit time of a first uplink reference signal, and a second time gap between the second receipt time and a second transmit time of a second uplink reference signal.

In some embodiments, the wireless communication device may receive, from the wireless communication node via at least a first signaling, at least one of: a first trigger to support the network based determination of the single location, a second trigger of a round trip time (RTT) measurement, a third trigger of a timing advance (TA) report, a fourth trigger of periodic transmission of reference signals (RSs), at least one type of information to be reported by the wireless communication device to the wireless communication node, a reporting method for the wireless communication device to report the at least one type of information, a scheduling configuration for the wireless communication device to report the at least one type of information, a number of positioning-related measurements or reports, to be utilized to determine the single location of the wireless communication device, or a time window for positioning-related measurements or reports, to be utilized for collecting positioning-related measurements to determine the single location of the wireless communication device. In some embodiments, the at least a first signaling may comprise at least one of: a radio resource control (RRC) signaling or a system information block (SIB) signaling.

In some embodiments, the first positioning-related information and the second positioning-related information may comprise at least one of: a time gap between receipt of a downlink reference signal and transmission of a corresponding uplink reference signal, a coherence level between different uplink reference signals, a timing advance (TA) value, trajectory information of the wireless communication device, a mobility status of the wireless communication device, a capability or type of the wireless communication device, or a timestamp corresponding to any preceding type of information. The mobility status of the wireless communication device may comprise at least one of: a speed value, a movement direction, a velocity vector, or an indication of speed range, of the wireless communication device. The coherence level between the different uplink reference signals may comprise a level of coherence between the different uplink reference signals' phase values, carrier frequency values, or timing values.

In some embodiments, the wireless communication device may receive a single trigger to perform a plurality of round trip time (RTT) measurements on a periodic or aperiodic sequence of reference signals from the wireless communication node. The wireless communication device may determine a time gap between receipt of a downlink reference signal and transmission of a corresponding uplink reference signal. The wireless communication device may send the time gap to the wireless communication node.

In some embodiments, the first positioning-related information of the first time instance can be with respect to a wireless communication node, and the second positioning-related information of the second time instance can be with respect to the wireless communication node or another wireless communication node.

The first positioning-related information and the second positioning-related information can be part of a defined number of positioning-related measurements or reports, to be utilized to determine the single location of the wireless communication device. In certain embodiments, the network based determination of the single location of the wireless communication device cannot be thought reliable if a number of positioning-related measurements or reports is lower than the defined number of positioning-related measurements or reports.

The first positioning-related information and the second positioning-related information can be provided within a defined time window for collecting positioning-related measurements or reports, to be utilized to determine the single location of the wireless communication device. In certain embodiments, the network based determination of the single location of the wireless communication device cannot be thought reliable if a time for collecting positioning-related measurements or reports is shorter than the defined time window for collecting positioning-related measurements or reports.

In some embodiments, the wireless communication device may receive one or more trigger signals for a plurality of timing advance (TA) reports from the wireless communication node. The wireless communication device may send the plurality of TA reports each at a respective time instance to the wireless communication node. The wireless communication node may receive or set a reliability flag corresponding to the wireless communication device according to the network based determination of the single location. The reliability flag may indicate whether the wireless communication device is reliable for a defined period of time. In certain embodiments, the reliability flag can be associated with at least one of: an international mobile equipment identity (IMEI), an international mobile subscriber identity (IMSI), a radio network temporary identity (RNTI), or other defined virtual identity (ID).

At least one aspect is directed to a system, method, apparatus, or a computer-readable medium. A wireless communication node (e.g., a ground terminal, a base station, a gNB, an eNB, or a serving node) may receive information to indicate or determine a reliability of a determination of a location of a wireless communication device from a core network. The wireless communication node may determine whether to terminate a connection with the wireless communication device, according to the information. The information may comprise a result of the core network's determination of the reliability. The information may comprise the core network's estimate of a positioning-related metric. The communication node may determine the reliability by comparing the core network's estimate against the wireless communication node's estimate of the positioning-related metric. The wireless communication node may determine whether to terminate a connection with the wireless communication device, according to the wireless communication node's determination of the reliability.

In some embodiments, the wireless communication node may send, to the core network, an indication of at least one of: the wireless communication node's determination of the reliability, whether to terminate a connection with the wireless communication device, or whether the wireless communication device can be allowed to access a network of the wireless communication node. The wireless communication node may indicate whether the wireless communication device can be allowed to access a network of the wireless communication node to the wireless communication device. The wireless communication node may receive, via at least one first signaling, at least one of: at least one round trip time (RTT) measurement, at least one time difference of arrival (UL-TDOA) measurement, at least one timing advance (TA) report, at least one timestamp corresponding to any type of preceding information, or a criteria for verifying the reliability.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example Non-Terrestrial Network (NTN), in accordance with some embodiments of the present disclosure;

FIG. 4 illustrates an example uplink time difference of arrival (UL-TDOA) method, in accordance with some embodiments of the present disclosure;

FIG. 5 illustrates an example multi-cell round trip time (multi-RTT) method, in accordance with some embodiments of the present disclosure;

FIG. 6 illustrates an example procedure of estimating round trip time (RTT), in accordance with some embodiments of the present disclosure;

FIGS. 7A-7D illustrate related aspect of network based positioning, in accordance with some embodiments of the present disclosure;

FIG. 8 illustrates an example of positioning by a single satellite/aerial vehicle, in accordance with some embodiments of the present disclosure;

FIGS. 9A-9B illustrate example procedures of estimating RTTs corresponding to multiple time instants with one request, in accordance with some embodiments of the present disclosure;

FIG. 10 illustrates an example approach for periodically reporting time information, in accordance with some embodiments of the present disclosure; and

FIG. 11 illustrates a flow diagram of an example method for network based positioning, in accordance with an embodiment of the present disclosure;

FIG. 12 illustrates a flow diagram of an example method for network based positioning, in accordance with an embodiment of the present disclosure.

### DETAILED DESCRIPTION

### 1. Mobile Communication Technology and Environment

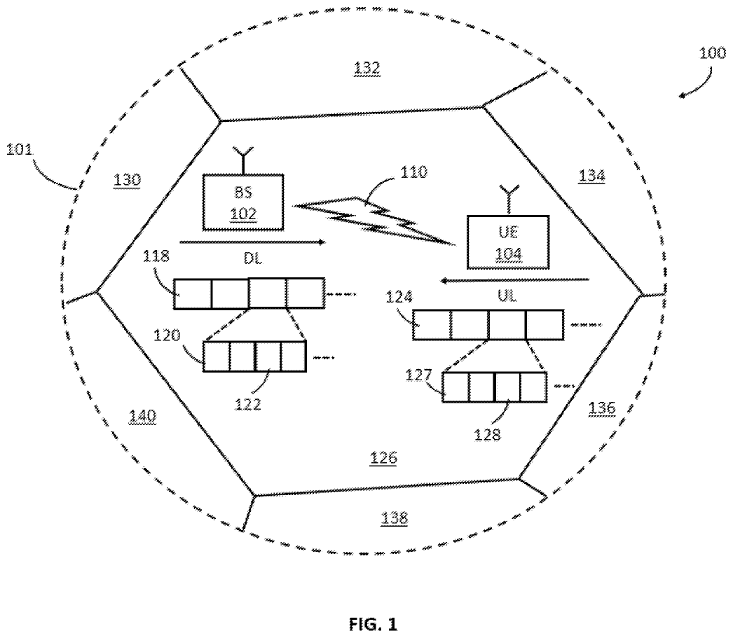

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

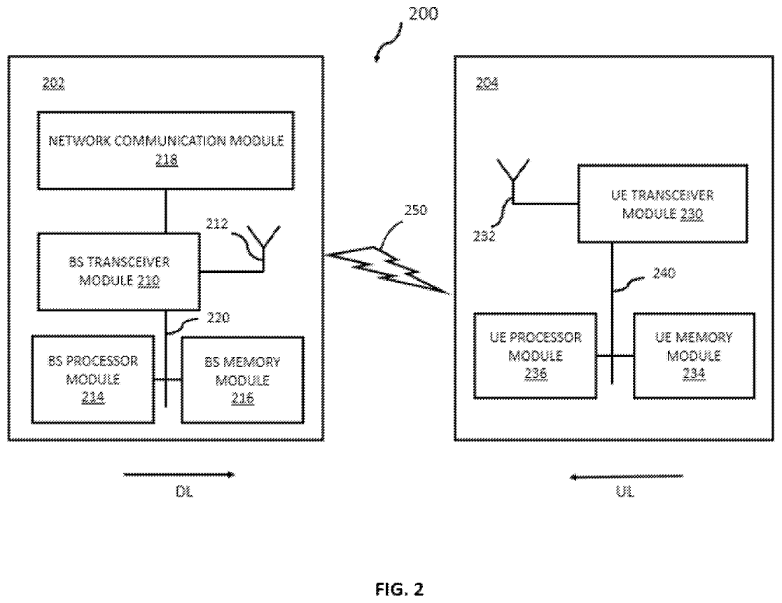

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Network Based Positioning

Non-Terrestrial Network (NTN) user equipment (UE) can be implemented with Global Navigation Satellite System (GNSS) capability and can be configured to obtain/determine the UE's location. However, GNSS based positioning method is radio access technology (RAT) independent. A UE position obtained by GNSS may not be reliable/trustable by the network. Hence, how to obtain and/or verify the UE's position by network based positioning is a problem that the present disclosure recognizes and provides solutions to address. The systems and methods presented herein include novel approaches for network based positioning.

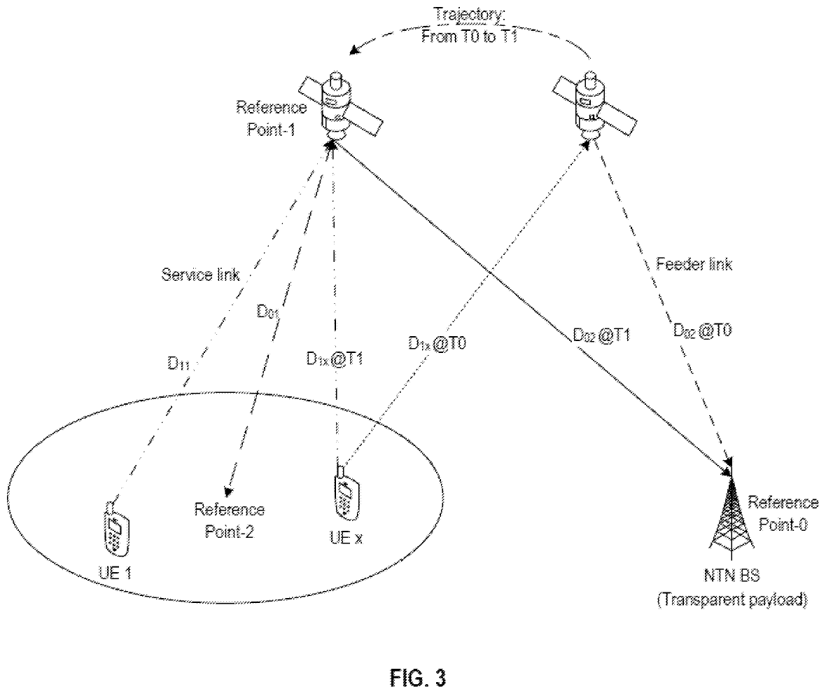

FIG. 3 illustrates an example representation of a NTN, e.g., a transparent NTN. In some embodiments, the link between a UE and a satellite may be a service link The link between a base station (BS) and a satellite may be a feeder link The feeder link delay may be common for all UEs within the same cell. There may be multiple methods for network based positioning in terrestrial network (TN), which can be radio access technology dependent and can be reliable/trustable. However, the methods may require/involve the UE communicating with multiple base stations simultaneously, which may not be supported in some NTN specifications.

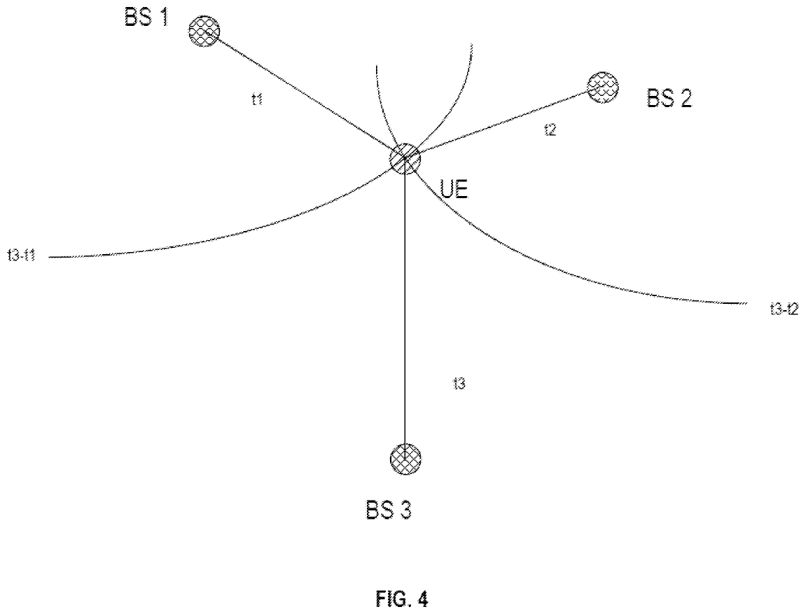

FIG. 4 illustrates an example uplink time difference of arrival (UL-TDOA) method. In some embodiments, a UE can be configured to transmit UL reference signals (RSes). Multiple base stations (BSs) may measure the uplink (UL) RS from the UE to estimate the TDOA. Based on the TDOA, multiple hyperbolic curves can be obtained and the estimated UE position can be determined at the intersection point. In order to avoid a clock error between BSs in the TDOA estimation, the multiple BSs may be well synchronized.

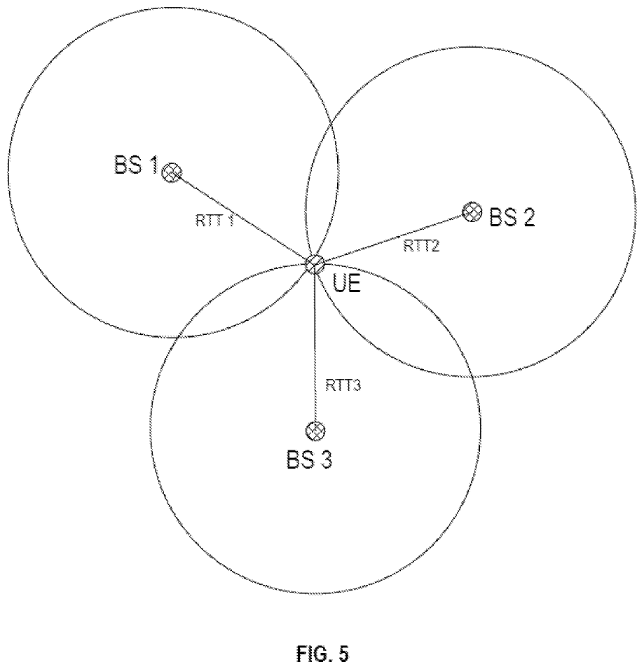

FIG. 5 illustrates an example multi-cell round trip time (multi-RTT) method. The network may estimate multiple RTTs between a UE and different BSs. The network can be able to know a distance between a UE and several reference points (e.g., BS locations), and can perform positioning through geometric calculation. In order to estimate the RTT, both DL and UL RSs may be configured. The network may first transmit the DL RS at time to. The UE may receive the DL RS at t₁, and may transmit UL RS at t₂. After transmitting UL RS, UE may report a time interval (t₂−t₁). The network may receive the UL RS at t₃ and can be able to obtain the RTT as (t₃−t₀)−(t₂−t₁). Compared to the UL-TDOA, the BSs may not be required to be well synchronized since independent RTTs can be measured. The procedure of estimating RTT can be seen in FIG. 4.

In NTN, timing advance (TA) pre-compensation can be applied for UL synchronization to handle the large propagation delay. The network can indicate a satellite (or other reference point) position (e.g., location coordinates or satellite ephemeris) to a UE. As a result, a UE can estimate the service link delay through geometric calculation based on its own location obtained by GNSS positioning and satellite position indicated from network. Moreover, TA report can also be supported since the network may need to know the pre-compensated TA at a UE to arrange scheduling of transmissions/communications. In some embodiments, a service link TA can be equal/equivalent/similar/related to the RTT between a UE and a satellite, which can be considered for network based positioning. Although the calculation of a pre-compensated TA value can be related to the GNSS system, it can be reliable/trustable since UE may not access the network without correct TA pre-compensation.

### Implementation Example 1—Network Based Positioning

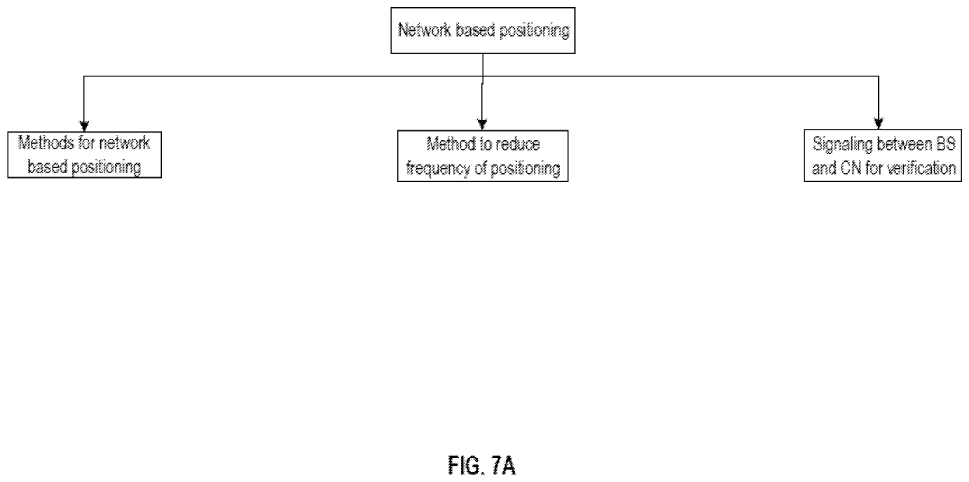

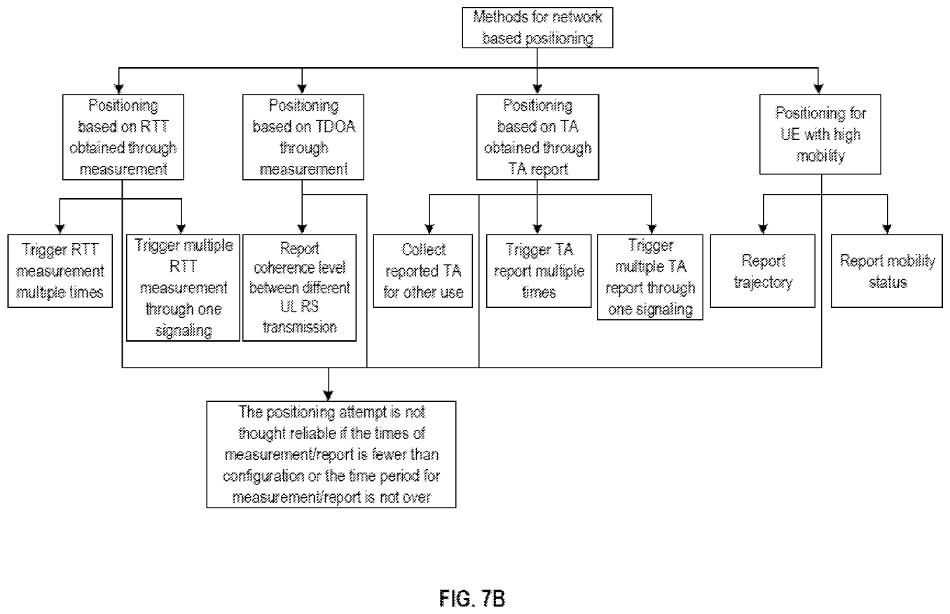

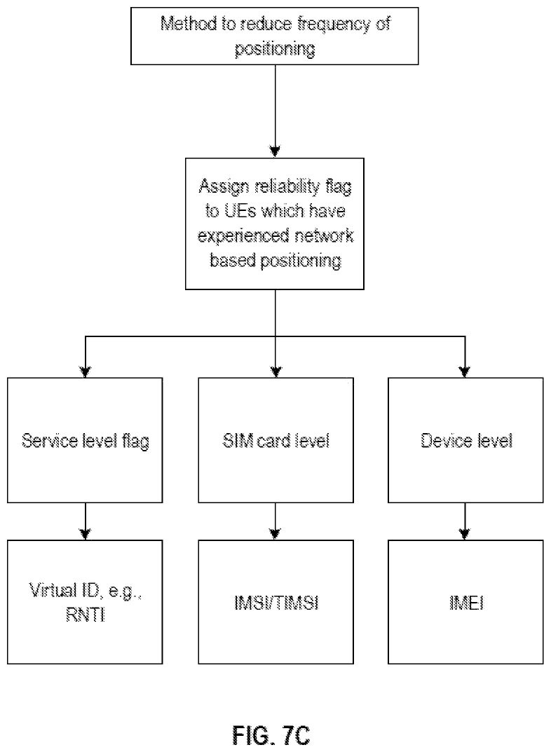

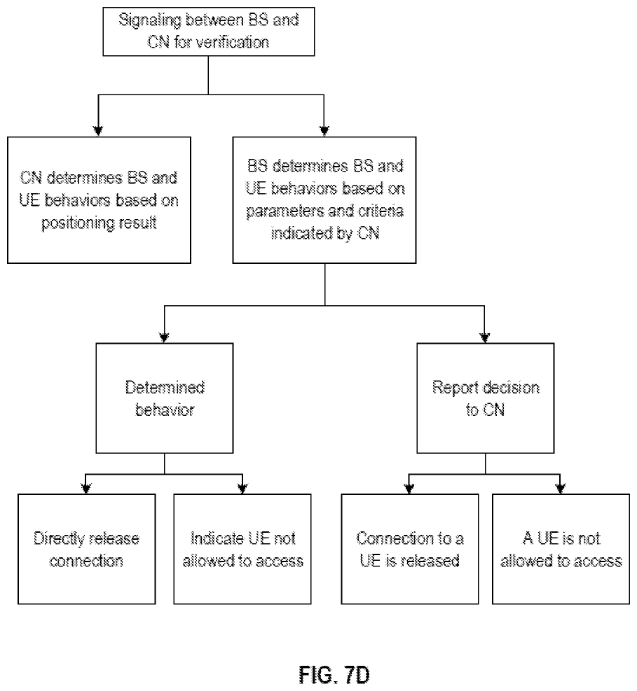

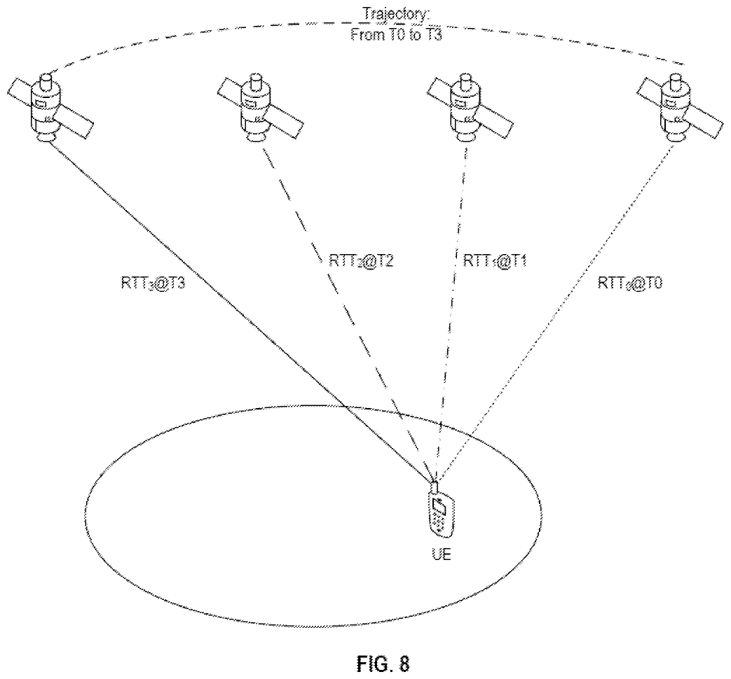

FIGS. 7A-7D illustrate related aspects of network based positioning. In current NTN, there may not be enough satellites available for communication at a same time. A method utilizing multiple BSs for positioning can be hard to be directly adopted in NTN. However, due to the mobility of satellite/aerial vehicle, multiple RTTs/TDOAs/TAs may be obtained using only one satellite/aerial vehicle/gateway (GW)/BS (as shown in FIG. 8) if a processing time/duration of positioning can be allowed/enabled/supported to be long. The following methods can be considered for network based positioning.

### A. Example Method-1

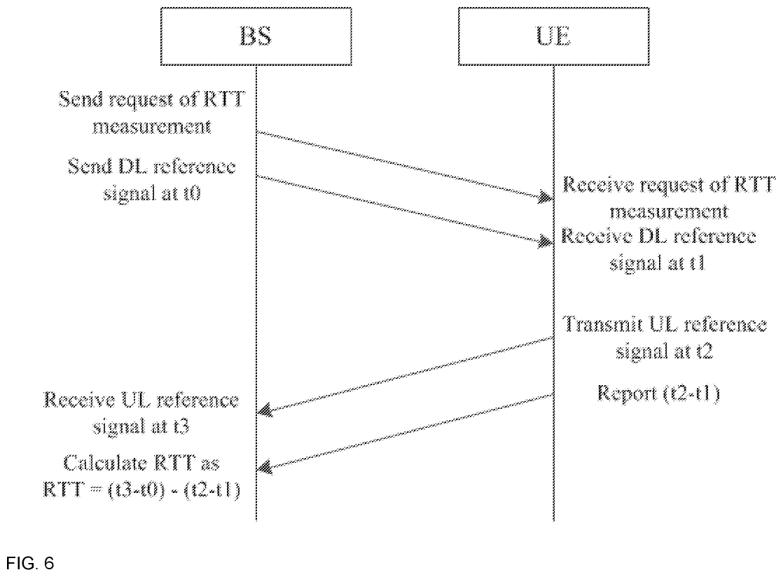

FIG. 8 illustrates an example of positioning by using a single satellite/aerial vehicle. In some embodiments, the network may utilize UL and DL RSs to estimate multiple RTTs at different time instants. RTTs corresponding to a same BS/satellite/aerial vehicle at different time instants can be estimated in NTN. In TN, the RTTs can correspond to multiple fixed BSs at different places. To accommodate the method, the following signaling design can be considered between a BS and a UE. The RTT measurement procedure shown in FIG. 6 can be reused. The BS can perform the measurement procedure multiple times at different time instants, and can collect the results to estimate the UE's position.

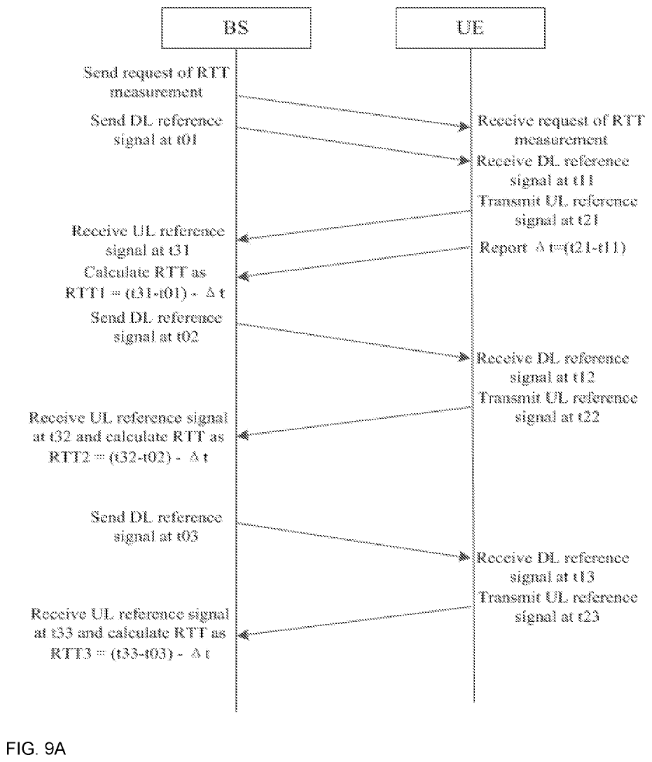

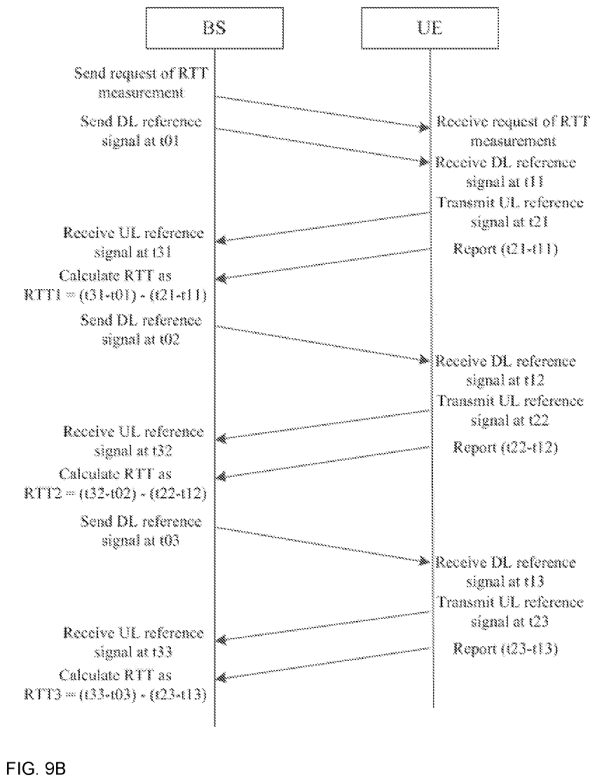

In some embodiments, the RTT measurement may be triggered only once (e.g., the request sent only once), but a periodic RS transmission can be configured. The period of RS can be indicated in the request message, or can be separately configured via a system information block (SIB) broadcast and/or a dedicated radio resource control (RRC) signaling. If a time gap between receiving DL RS and transmitting UL RS at UE is fixed, the UE can report the time gap only once after first or last transmission of UL RS as shown in FIG. 9A. Otherwise, the UE may report the time gap after every transmission of UL RS as shown in FIG. 9B.

### B. Example Method-2

Similar to Method-1, the network may utilize uplink reference signals (UL RSs) to estimate TDOAs at different time instants. The UL-TDOA method in TN can be enhanced to accommodate NTN by revising multi-BS measurements at a same time to multi-time measurements by a same BS. Since a UL RS transmission can be configured by the network, the network can be able to preclude the time interval between different RS transmissions in the TDOA estimation.

However, in this method, the time interval between different uplink UL RS transmission may be long (e.g., tens of seconds). If the radio frequency (RF) is not stable enough, the coherence between different UL RS transmissions may not be good enough, which may cause a TDOA estimation error. In order to allow the network to obtain/determine confidence of/in the estimated UE position, the coherence level between different UL RS transmissions can be reported by the UE. In certain embodiments, the coherence level between the different UL RSs may comprise a level of coherence between the different uplink reference signals' phase values, carrier frequency values, and/or timing values.

### C. Example Method-3

In some embodiments, a UE may report timing advance (TA) pre-compensation values applied in a UL synchronization corresponding to different time instants. If the UE does not apply a correct TA pre-compensation value, a UL synchronization can be lost. Hence, the reported TA pre-compensation value may be thought to be reliable/trustable although the reported TA pre-compensation value can be calculated based on the UE location obtained through a GNSS. Since a service link TA may correspond to a RTT between the UE and a satellite/aerial vehicle, the network can utilize the information for positioning through a similar method as multi-RTT. The advantage of this method can be that there may be no need to configure RSs for measurement.

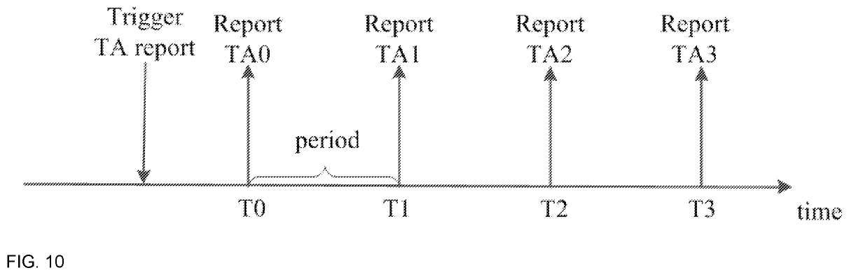

To accommodate the method, the following signaling design can be considered between a BS and a UE. The network may directly collect the reported TA values from the UE, which may be reported for other purposes such as scheduling, and may estimate the UE location. In some embodiments, the network may send a trigger indication of a TA report to the UE to report a TA each time when needed. For example, the UE may receive one trigger for each report. In certain embodiments, the UE may receive one single trigger to trigger a periodic series of reports. By collecting the reported TA values, the network can estimate the UE location. In certain embodiments, the network may send a trigger indication of positioning to the UE, and may configure the UE to report a TA periodically as shown in FIG. 10. By collecting the reported TA values, the network can estimate the UE location.

The UE may also report a time instant corresponding to the TA value. With the time instant, the network can be able to know an exact satellite/aerial vehicle position which the UE utilized to calculate a TA. The accuracy of positioning can be further improved.

### D. Example Method-4

In some embodiments, a UE may report trajectory information and/or a mobility status to assist a network based positioning for high mobility case. This can be an add-on method, which may be combined with any of Method-1 to Method-3. As discussed before, the RTTs can be measured at different time instants. As a result, the UE's location may change before finishing the positioning procedure in a high mobility scenario. To address this case, the UE can report the trajectory information and/or the mobility status, which can allow/enable/support the network to take the UE mobility into consideration when performing positioning.

A satellite may have a fixed orbit. There can be ambiguity for a UE positioning along an axis perpendicular to the orbit plane. For example, if the satellite orbit is in the x-y plane, the network cannot distinguish the point (x, y, z) and (x, y, −z) since a measured RTTs can be same. In such case, the satellite may utilize an angle-of-arrival of signal to judge/determine/decide the UE location.

Compared to TN methods which may utilize multi locations of different BSs, the methods which utilize multi locations of single BS at different time instants may have similar estimation principles but collect positioning information through different ways. Hence, the methods can be defined as a separate operation mode. More specifically, there may be following two modes for positioning. For a first one of the modes, the TA may report and/or perform measurement corresponding to single (e.g., one fixed BS) or multiple satellites/aerial vehicles/BSs/transmission reception points (TRPs) at different time instants. For example, a first positioning-related information of the first time instance can be with respect to a satellite/aerial vehicle/BS/TRP, and a second positioning-related information of a second time instance can be with respect to the satellite/aerial vehicle/BS/TRP. This can be used for the cases where there may not be enough satellites/aerial vehicles in sight. For another mode, the TA may report and/or perform measurement corresponding to different satellites/aerial vehicles/BSs. For example, a first positioning-related information of the first time instance can be with respect to a satellite/aerial vehicle/BS/TRP, and a second positioning-related information of a second time instance can be with respect to another satellite/aerial vehicle/BS/TRP. This can be used for cases where there may be enough satellites/aerial vehicles/BSs/TRPs for parallel TA reports and/or measurements. The two modes for positioning may be used for other methods.

For the first mode, the following two cases may be additionally defined. For one of the cases, N times of measurement/report and/or a time period can be considered for a one-time calculation of a location at a LMF. When a positioning is triggered, a radio access network (RAN) may perform a series of corresponding measurements/reports. For example, the RAN may perform a defined number of positioning-related measurements and/or reports to be utilized to determine a single location of a wireless communication device. After N times of measurements/reports and/or a period of time, one calculation procedure can be considered completed. If the number of measurements/reports and/or the period of time is not satisfied, the result of the positioning attempt may not be considered reliable/trustable/accurate enough. For another case, N times of measurements/reports and/or a time period can be considered as a defined window for a LMF to collect the report(s) from a RAN. When a positioning procedure is triggered, the RAN may perform a series of corresponding measurements/reports. For example, the LMF may provide a defined time window for collecting positioning-related measurements and/or reports to be utilized to determine a single location of a wireless communication device. The LMF may collect information from the RAN during the defined time window for positioning (not limited to only one time calculation). If the measurements/report terminates/ends before the end of time window, the result of the positioning attempt may not be considered reliable/trustable/accurate enough.

In some embodiments, the wireless communication device (e.g., user equipment) may send at least a first positioning-related information of a first time instance and a second positioning-related information of a second time instance to a wireless communication node (e.g., base station). The wireless communication device may determine at least a first measurement of a receipt time of a first downlink reference signal, and a second measurement of a receipt time of a second downlink reference signal. The wireless communication device may determine at least a first time gap between the first receipt time and a first transmit time of a first uplink reference signal, and a second time gap between the second receipt time and a second transmit time of a second uplink reference signal.

In some embodiments, the first positioning-related information and the second positioning-related information may comprise at least one of: a time gap between receipt of a downlink reference signal and transmission of a corresponding uplink reference signal, a coherence level between different uplink reference signals, a timing advance (TA) value, trajectory information of the wireless communication device, a mobility status of the wireless communication device, a capability or type of the wireless communication device, or a timestamp corresponding to any preceding type of information. The mobility status of the wireless communication device may comprise at least one of: a speed value, a movement direction/angle/vector, a velocity vector, or an indication of speed range, of the wireless communication device. The coherence level between the different uplink reference signals may comprise a level of coherence between the different uplink reference signals' phase values, carrier frequency values, or timing values.

In some embodiments, there may be multiple times of reports corresponding to one trigger. For the network side, at least one of following configurations via a system information block (SIB) signaling and/or a radio resource control (RRC) signaling may be supported. The wireless communication device may receive, from the wireless communication node via at least a first signaling, at least one of: a first trigger to support the network based determination of the single location, a second trigger of a round trip time (RTT) measurement (e.g., a single RTT measurement), a third trigger of a timing advance (TA) report, a fourth trigger of periodic transmission of reference signals (RSs), at least one type of information to be reported by the wireless communication device to the wireless communication node, a reporting method for the wireless communication device to report the at least one type of information, a scheduling configuration for the wireless communication device to report the at least one type of information (e.g., time domain and frequency domain information, as well as resources scheduled for the reporting), a number of positioning-related measurements or reports, to be utilized to determine the single location of the wireless communication device, or a time window for positioning-related measurements or reports, to be utilized for collecting positioning-related measurements to determine the single location of the wireless communication device.

### Implementation Example 2—Reliability Flag

The methods introduced in implementation example 1 may require/involve a long time to collect RTTs. To reduce cost, the network can assign a reliability flag to the UEs which may have experienced a network based positioning. For example, a UE near the country border may want to access the network. The network may utilize a network based positioning to judge/determine/decide whether the UE may want to access the network of its own country. If the UE aims to access correct network, the network may assign a reliable flag to the UE for a period of time, during which the positioning procedure can be avoided if the UE tries to access the network. Otherwise, the network may assign an unreliable flag to UE for a period of time, during which the network may reject the access from the UE.

The reliability flag may indicate whether the wireless communication device is reliable for a defined period of time. In certain embodiments, the reliability flag can be associated with at least one of: an international mobile equipment identity (IMEI), an international mobile subscriber identity (IMSI), a radio network temporary identity (RNTI), or other defined virtual identity (ID). There can be multiple levels of reliability flag, which may include at least one of followings: a service level or an entity level. The service level can be a temporary reliability flag assignment. The entity level can be stricter than service level since the long-term flag can assigned. The entity level can be further divided into following levels. In certain embodiments, the reliability flag can be assigned to IMSI/TIMSI, which can be associated with a subscriber identity module (SIM) card. In some embodiments, the UE reports the IMEI first. The reliability flag can be assigned to the IMEI, which can be associated with a device. The reliability flag can be valid even if the SIM card is changed. In some embodiments, UE may report at least one of its IMEI, IMSI, RNTI, and/or a defined virtual ID to network.

### Implementation Example 3—Signaling Between BS and CN on Location Verification

In core network (CN), there may be a location management function (LMF) server which can handle location related functions. In TN positioning methods, measurement results can be transmitted to the LMF to perform a final location estimation. However, where to perform a verification procedure (e.g., determine whether the UE can allowed/enabled/supported to access the network) may not be determined yet. Hence, one or more of the following ways may be adopted.

In some embodiments, the CN may determine BS and UE behaviors based on a positioning result. In this case, the BS may forward a collected information used for positioning (e.g., RTTs, TAs, TDOAs, trajectory information, mobility status, or time instants) to the CN. In some embodiments, the CN may perform a location verification, and may verify a reliability of a UE. The CN may indicate the reliability of the UE to a BS. The CN may estimate the UE location, and may determine the BS and UE behaviors. For example, if an estimated UE location is on the other side of country border, a BS may release/terminate/end a connection with the UE since the access can be irregular/improper/invalid. If the UE is allowed to report its location, the CN may compare the estimated location and the reported location. The CN may determine to release the connection with the UE if an error is larger than certain threshold.

In some embodiments, a RAN may determine BS and UE behaviors based on criteria indicated by CN. Although it may be not preferred to let the BS know the UE's position, it can be possible to verify the location via other related parameters indicated from the CN. For example, the CN can estimate the TDOAs corresponding to a certain location, and can indicate the TDOAs/estimated values to the BS. The BS may perform a location verification. The BS can be able to compare the measured TDOAs with the estimated values indicated by the CN to determine/verify the reliability. If an error is larger than certain threshold, the BS may think/determine/decide that the UE is not accessing the correct network. The BS may release/terminate/end the connection with the UE, and may report the decision/indication to the CN. The threshold for releasing different types of UEs may be different since the UE capability can vary.

To accommodate above ways of verification, a BS may support at least one of the following functions. The wireless communication node (e.g., BS) may receive, from the CN, via at least one first signaling, at least one of: at least one round trip time (RTT) measurement, at least one time difference of arrival (UL-TDOA) measurement, at least one timing advance (TA) report, at least one timestamp corresponding to any type of preceding information, or a criteria for verifying the reliability (e.g., threshold for error between indicated parameters and measurements). There may be multiple criteria for different UE capabilities/types. In some embodiments, the BS may determine the reliability by comparing the core network's estimate/criteria/parameters against the BS's estimate/criteria/parameters of a positioning-related metric. The BS may determine whether to terminate a connection with the UE, according to the BS's determination of the reliability. In some embodiments, the BS may release/end the connection with the UE. In certain embodiments, the BS may indicate to the UE that the UE may not be allowed to access the network.

In some embodiments, the BS may send, to the core network, an indication/decision of at least one of: the wireless communication node's determination of the reliability, whether to terminate a connection with the wireless communication device, or whether the wireless communication device can be allowed to access a network of the wireless communication node. In some embodiments, the BS may release the connection with the UE. In certain embodiments, the BS may indicate to the UE that the UE may not be allowed to access the network.

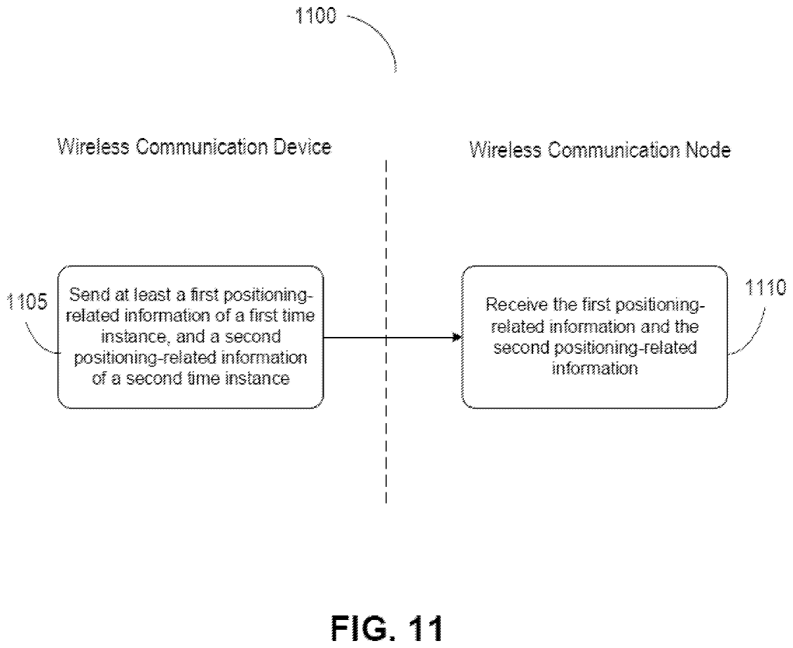

FIG. 11 illustrates a flow diagram of a method 1100 for network based positioning. The method 1100 may be implemented using any of the components and devices detailed herein in conjunction with FIGS. 1-10. In overview, the method 1100 may include sending, from a wireless communication device to a wireless communication node, at least a first positioning-related information of a first time instance, and a second positioning-related information of a second time instance.

Referring now to operation (1105), and in some embodiments, a wireless communication device (e.g., user equipment) may send at least a first positioning-related information of a first time instance and a second positioning-related information of a second time instance to a wireless communication node (e.g., base station). The first positioning-related information and the second positioning-related information can be used collectively to perform a network based determination of a single location of the wireless communication device. In some embodiments, the wireless communication device may determine at least a first measurement of a receipt time of a first downlink reference signal, and a second measurement of a receipt time of a second downlink reference signal. The wireless communication device may determine at least a first time gap between the first receipt time and a first transmit time of a first uplink reference signal, and a second time gap between the second receipt time and a second transmit time of a second uplink reference signal.

In some embodiments, the wireless communication device may receive, from the wireless communication node via at least a first signaling, at least one of: a first trigger to support the network based determination of the single location, a second trigger of a round trip time (RTT) measurement, a third trigger of a timing advance (TA) report, a fourth trigger of periodic transmission of reference signals (RSs), at least one type of information to be reported by the wireless communication device to the wireless communication node, a reporting method for the wireless communication device to report the at least one type of information, a scheduling configuration for the wireless communication device to report the at least one type of information, a number of positioning-related measurements or reports, to be utilized to determine the single location of the wireless communication device, or a time window for positioning-related measurements or reports, to be utilized for collecting positioning-related measurements to determine the single location of the wireless communication device. In some embodiments, the at least a first signaling may comprise at least one of: a radio resource control (RRC) signaling or a system information block (SIB) signaling.

In some embodiments, the first positioning-related information and the second positioning-related information may further comprise at least one of: a time gap between receipt of a downlink reference signal and transmission of a corresponding uplink reference signal, a coherence level between different uplink reference signals, a timing advance (TA) value, trajectory information of the wireless communication device, a mobility status of the wireless communication device, a capability or type of the wireless communication device, or a timestamp corresponding to any preceding type of information. The mobility status of the wireless communication device may comprise at least one of: a speed value, a movement direction, a velocity vector, or an indication of speed range, of the wireless communication device. The coherence level between the different uplink reference signals may comprise a level of coherence between the different uplink reference signals' phase values, carrier frequency values, or timing values.

In some embodiments, the wireless communication device may receive a single trigger to perform a plurality of round trip time (RTT) measurements on a periodic or aperiodic sequence of reference signals from the wireless communication node. The wireless communication device may determine a time gap between receipt of a downlink reference signal and transmission of a corresponding uplink reference signal. The wireless communication device may send/indicate the time gap to the wireless communication node.

In some embodiments, the first positioning-related information of the first time instance (e.g., first time instant or occurrence) can be with respect to a wireless communication node, and the second positioning-related information of the second time instance can be with respect to the wireless communication node or another wireless communication node. The first positioning-related information and the second positioning-related information can be part of a defined number of positioning-related measurements or reports, to be utilized to determine the single location of the wireless communication device. In certain embodiments, the network based determination of the single location of the wireless communication device cannot be thought reliable if a number of positioning-related measurements or reports is lower than the defined number of positioning-related measurements or reports. The first positioning-related information and the second positioning-related information can be provided within a defined time window for collecting positioning-related measurements or reports, to be utilized to determine the single location of the wireless communication device. In certain embodiments, the network based determination of the single location of the wireless communication device cannot be thought reliable if a time for collecting positioning-related measurements or reports is shorter than the defined time window for collecting positioning-related measurements or reports.

In some embodiments, the wireless communication device may receive one or more trigger signals for a plurality of timing advance (TA) reports from the wireless communication node. The wireless communication device may send the plurality of TA reports each at a respective time instance to the wireless communication node. The wireless communication node may receive or set a reliability flag corresponding to the wireless communication device according to the network based determination of the single location. The reliability flag may indicate whether the wireless communication device is reliable for a defined period of time. In certain embodiments, the reliability flag can be associated with at least one of: an international mobile equipment identity (IMEI), an international mobile subscriber identity (IMSI), a radio network temporary identity (RNTI), or other defined virtual identity (ID).

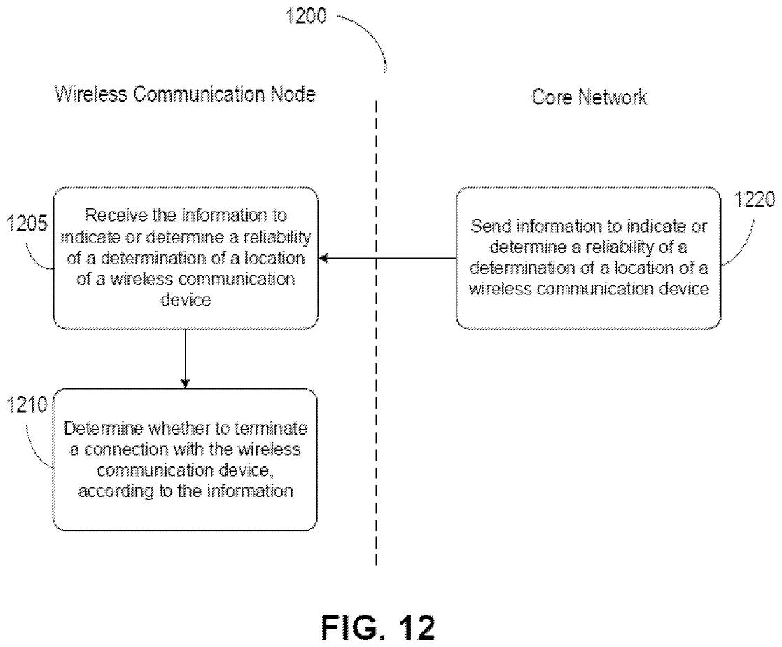

FIG. 12 illustrates a flow diagram of a method 1200 for network based positioning. The method 1200 may be implemented using any of the components and devices detailed herein in conjunction with FIGS. 1-10. In overview, the method 1200 may include receiving, by a wireless communication node from a core network, information to indicate or determine a reliability of a determination of a location of a wireless communication device. The method 1200 may include determining, by the wireless communication node, whether to terminate a connection with the wireless communication device, according to the information.

At least one aspect is directed to a system, method, apparatus, or a computer-readable medium. Referring now to operation (1205), and in some embodiments, a wireless communication node (e.g., a ground terminal, a base station, a gNB, an eNB, or a serving node) may receive information to indicate or determine a reliability of a determination of a location of a wireless communication device (e.g., a network-based determination or a UE-based determination of a UE's location) from a core network. Referring now to operation (1210), and in some embodiments, the wireless communication node may determine whether to terminate a connection with the wireless communication device, according to the information. The information may comprise a result of the core network's determination of the reliability. The information may comprise the core network's estimate/projection/calculation of a positioning-related metric. The communication node may determine the reliability by comparing the core network's estimate against the wireless communication node's estimate of the positioning-related metric. The wireless communication node may determine whether to terminate/release/end a connection with the wireless communication device, according to the wireless communication node's determination of the reliability.

In some embodiments, the wireless communication node may send, to the core network, an indication of at least one of: the wireless communication node's determination of the reliability, whether to terminate a connection with the wireless communication device, or whether the wireless communication device can be allowed to access a network of the wireless communication node. The wireless communication node may indicate whether the wireless communication device can be allowed to access a network of the wireless communication node to the wireless communication device. The wireless communication node may receive, via at least one first signaling, at least one of: at least one round trip time (RTT) measurement, at least one time difference of arrival (UL-TDOA) measurement, at least one timing advance (TA) report, at least one timestamp corresponding to any type of preceding information, or a criteria for verifying the reliability.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
sending, by a wireless communication device to a wireless communication node, at least a first positioning-related information of a first time instance, and a second positioning-related information of a second time instance, to use collectively to perform a network based determination of a single location of the wireless communication device.

2. The method of claim 1, comprising:
determining, by the wireless communication device, at least a first measurement of a receipt time of a first downlink reference signal, and a second measurement of a receipt time of a second downlink reference signal; and
determining, by the wireless communication device, at least a first time gap between the first receipt time and a first transmit time of a first uplink reference signal, and a second time gap between the second receipt time and a second transmit time of a second uplink reference signal.

3. The method of claim 1, comprising:
receiving, by the wireless communication device from the wireless communication node via at least a first signaling, at least one of:
a first trigger to support the network based determination of the single location,
a second trigger of a round trip time (RTT) measurement,
a third trigger of a timing advance (TA) report,
a fourth trigger of periodic transmission of reference signals (RSs),
at least one type of information to be reported by the wireless communication device to the wireless communication node,
a reporting method for the wireless communication device to report the at least one type of information,
a scheduling configuration for the wireless communication device to report the at least one type of information,
a number of positioning-related measurements or reports, to be utilized to determine the single location of the wireless communication device, or
a time window for positioning-related measurements or reports, to be utilized for collecting positioning-related measurements to determine the single location of the wireless communication device.

4. The method of claim 3, wherein:
the at least a first signaling comprises at least one of: a radio resource control (RRC) signaling or a system information block (SIB) signaling.

5. The method of claim 2, wherein:
the first positioning-related information and the second positioning-related information further comprises at least one of:
a time gap between receipt of a downlink reference signal and transmission of a corresponding uplink reference signal,
a coherence level between different uplink reference signals,
a timing advance (TA) value,
trajectory information of the wireless communication device,
a mobility status of the wireless communication device,
a capability or type of the wireless communication device, or
a timestamp corresponding to any preceding type of information.

6. The method of claim 5, wherein the mobility status of the wireless communication device comprises at least one of: a speed value, a movement direction, a velocity vector, or an indication of speed range, of the wireless communication device.

7. The method of claim 5, wherein:
the coherence level between the different uplink reference signals comprises a level of coherence between the different uplink reference signals' phase values, carrier frequency values, or timing values.

8. The method of claim 1, comprising:
receiving, by the wireless communication device from the wireless communication node, a single trigger to perform a plurality of round trip time (RTT) measurements on a periodic or aperiodic sequence of reference signals.

9. The method of claim 1, comprising:
determining, by the wireless communication device, a time gap between receipt of a downlink reference signal and transmission of a corresponding uplink reference signal, and sending, by the wireless communication device to the wireless communication node, the time gap.

10. The method of claim 1, wherein:
the first positioning-related information of the first time instance is with respect to a wireless communication node, and the second positioning-related information of the second time instance is with respect to the wireless communication node or another wireless communication node.

11. The method of claim 10, wherein:
the first positioning-related information and the second positioning-related information are part of a defined number of positioning-related measurements or reports, to be utilized to determine the single location of the wireless communication device.

12. The method of claim 11, wherein:
the network based determination of the single location of the wireless communication device is unreliable if a number of positioning-related measurements or reports is lower than the defined number of positioning-related measurements or reports.

13. The method of claim 10, wherein:
the first positioning-related information and the second positioning-related information are provided within a defined time window for collecting positioning-related measurements or reports, to be utilized to determine the single location of the wireless communication device.

14. The method of claim 13, wherein:
the network based determination of the single location of the wireless communication device is unreliable if a time for collecting positioning-related measurements or reports is shorter than the defined time window for collecting positioning-related measurements or reports.

15. The method of claim 1, comprising:
receiving, by the wireless communication device from the wireless communication node, one or more trigger signals for a plurality of timing advance (TA) reports, and
sending, by the wireless communication device to the wireless communication node, the plurality of TA reports each at a respective time instance.

16. The method of claim 1, wherein the wireless communication node receives or sets a reliability flag corresponding to the wireless communication device according to the network based determination of the single location, the reliability flag indicating whether the wireless communication device is reliable for a defined period of time.

17. The method of claim 16, wherein:
the reliability flag is associated with at least one of:
an international mobile equipment identity (IMEI),
an international mobile subscriber identity (IMSI),
a radio network temporary identity (RNTI), or
other defined virtual identity (ID).

18. A wireless communication device, comprising:
at least one processor configured to:
send, via a transmitter to a wireless communication node, at least a first positioning-related information of a first time instance, and a second positioning-related information of a second time instance, to use collectively to perform a network based determination of a single location of the wireless communication device.

19. A method comprising:
receiving, by a wireless communication node from a wireless communication device, at least a first positioning-related information of a first time instance, and a second positioning-related information of a second time instance, to use collectively to perform a network based determination of a single location of the wireless communication device.

20. A wireless communication node, comprising:
at least one processor configured to:
receive, via a receiver from a wireless communication device, at least a first positioning-related information of a first time instance, and a second positioning-related information of a second time instance, to use collectively to perform a network based determination of a single location of the wireless communication device.
